(19) United States
(12) Patent Application Publication
(10) Pub. No.: US 2010/0003375 A1
(43) Pub. Date: Jan. 7, 2010

(54) Candy dispenser with hard candy dipping pop

(76) Inventor: Jules R. Shecter, Boca Raton, FL (US)

Correspondence Address: ROBERT M. DOWNEY, P.A., 6751 N. FEDERAL HWY., SUITE 300, BOCA RATON, FL, 33487, US

(21) Appl. No.: 12/217,459

(22) Filed: Jul. 2, 2008

(51) Int. Cl. A23G 3/50

(52) U.S. Cl. 426/104

(57) ABSTRACT

A candy food product comprises a candy pop having a hard candy rod formed and supported at a support base, and a dispenser shaped as a personal electronic device for storing a plurality of confectionary powders. The dispenser includes a plurality of confectionary compartments for holding the confectionary powders. A lid selectively movable between an open and closed position sealingly engages the dispenser. A receptacle is formed in the dispenser proximate to the confectionary compartments and receives the candy pop therein.

### BACKGROUND OF THE INVENTION

1. Field of the Invention

The present invention relates to a novelty candy dispenser and more particularly, to a hard candy pop that is removably received in an imitation electronic device containing multiple confectionary powders so that the candy pop can be dipped in a choice of the powders and thus be consumed in conjunction with the confectionary powder.

2. Discussion of the Related Art

Lollipops and other hard candy pops have been traditionally placed on a stick to permit repeated removal and placement of the candy within one's mouth without having to touch the candy, thereby providing a convenient and sanitary means of consuming the candy product. Over the years, various hard candy pops have been produced in a multitude of shapes, sizes, and flavors. Additionally, candy pops have been formed around various supporting structures to provide additional novelty aspects to make the product more desirable.

These and other hard candy pops and holder devices provide a fun alternative to the traditional candy pop. In particular, children are attracted to candy pops and holders that incorporate some novelty aspect in addition to the flavor of the hard candy of the pop. For this reason, many children will choose a candy pop that incorporates a novelty feature over the more traditional forms of candy, such as candy pops on a plain stick.

While various configurations of candy pops include different sizes, shapes, single flavors, multi-flavors, and holders as novelty features to increase desire for the pops, probably the most important feature is flavor. Candy pops being essentially hard candy are primarily sugar and thus sweet. However, desired flavors are more than merely the sweetness of sugar, but also include recognizable flavors such as fruits to mimic naturally tasting foods we encounter in our nutritional intake. There are some favored combinations that include distinct flavor layers and textures as opposed to a homogenous hard candy incorporating all flavors into the hard candy such as caramel and apples or strawberries and chocolate. One such combination is a flavored hard candy pop that can be dipped into confectionary powder of a second flavor.

Thus, what is desired is a novelty candy dispenser that incorporates both a hard candy flavored pop and multiple flavored confectionary powders in which the flavored pop can be dipped.

### SUMMARY OF THE INVENTION

One aspect of the present invention is directed to a candy food dispenser including a candy pop having a confectionary product formed and supported by a holder and a container shaped as a personal electronics device for storing a confectionary powder. The container further defines a basin for holding the confectionary powder and has a closed bottom and sides and an open top, and a lid shaped as an element of the toy vehicle and sealingly engageable with the open top. A receptacle receiving the candy pop is formed in the toy vehicle container and located proximate to the basin.

These and other advantages of the invention will be further understood and appreciated by those skilled in the art by reference to the following written specification, claims and appended drawings.

### BRIEF DESCRIPTION OF THE DRAWINGS

For a fuller understanding of the nature of the present invention, reference should be made to the following detailed description taken in conjunction with the accompanying drawings in which:

FIG. 1 is a perspective view of a candy dispenser for a confectionary powder including a candy pop embodying the present invention;

FIG. 2 is an exploded perspective view of the dispenser illustrating an associated candy pop extracted therefrom;

FIG. 3 is an exploded perspective view of the dispenser illustrating an associated candy pop being dipped in a compartment of confectionary powder;

FIG. 4 is an exploded view of the dispenser illustrating an optional belt clip.

Like reference numerals refer to like parts throughout the several views of the drawings.

### DETAILED DESCRIPTION OF THE PREFERRED EMBODIMENTS

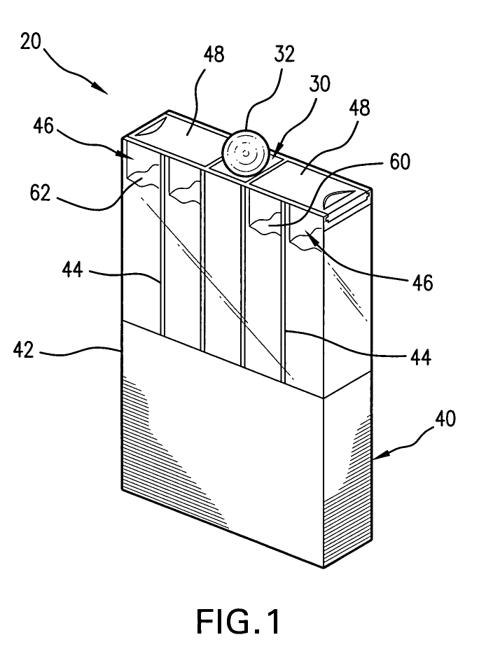

For purposes of description herein, the terms “upper”, “lower”, “left”, “rear”, “right”, “front”, “vertical”, “horizontal”, and derivatives thereof shall relate to the invention as oriented in FIG. 1. However, it is to be understood that the invention may assume various alternative orientations and step sequences, except where expressly specified to the contrary. While the present invention has been shown and described in accordance with preferred and practical embodiments thereof, it is recognized that departures from the instant disclosure are fully contemplated within the spirit and scope of the invention. Hence, specific dimensions and other physical characteristics relating to the embodiments disclosed herein are not to be considered as limiting, unless the claims expressly state otherwise.

Turning to the drawings, FIG. 1 shows a candy food product 20 comprising a candy pop 30 that is removably retained in a dispenser 40 that is typically shaped and sized to mimic a personal electronic device such as an MP3 player and is one of the preferred embodiments of the present invention and illustrates its various components. Optionally, an exterior of dispenser 40 can have applied thereon a decal or appliqué (not shown) having the printed image of a personal electronic device thereon to further the resemblance of food product 20 to that of a personal electronic device.

Referring to FIGS. 1-3 candy food product 20 includes a dispenser 40 having an external shape resembling the form of a personal electronic device. Dispenser 40 has a case 42 typically assuming a rectilinear form as shown wherein the width dimension is substantially less than the length and height dimensions. A plurality of dividers 44 are regularly spaced internal to and along the length of case 42 separating an interior of case 42 into a plurality of confectionary compartments 46. Each confectionary compartment 46 is typically filled with a flavored confectionary powder 60, 62 of differing desired flavors.

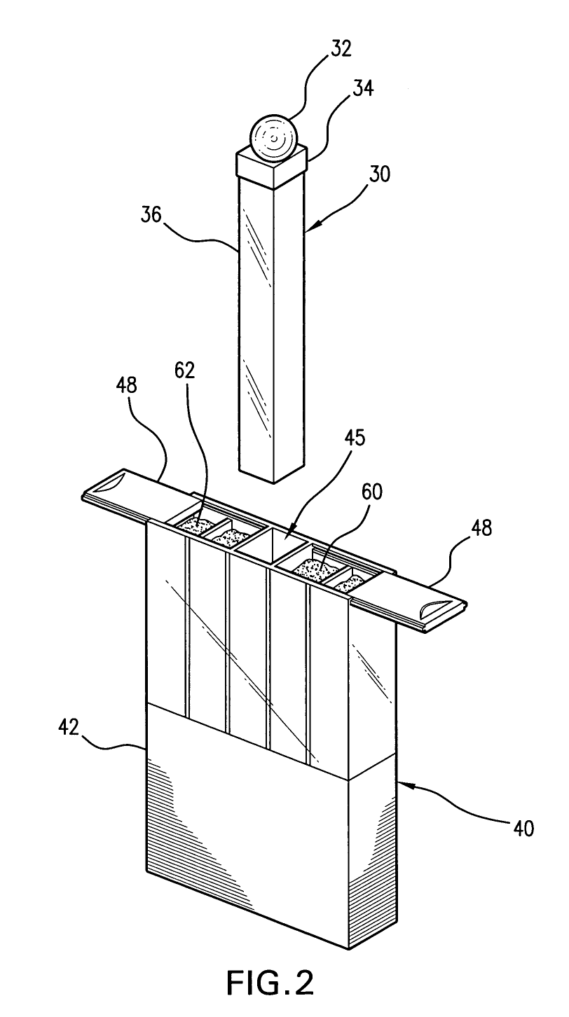

Thus, the multiple confectionary compartments 46 can contain a variety of different flavors of confectionary powders such as sour apple 60 in one compartment 46 and strawberry 62 in a different compartment 46 without the intermingling of flavors. Case 42 includes lids 48 which are selectively moveable between a closed position as shown in FIG. 1 and an open position as shown in FIG. 2 to seal confectionary compartments 46 thereby preventing confectionary powders 60, 62 from inadvertent spillage or contamination. Lids 48 may be slidably retained in a well known manner as shown in FIG. 2 or may alternately be hinged at one end for hinged opening (not shown) also in a well known manner.

As most clearly shown in FIG. 2, a candy pop 30 is shaped for storage in a central receptacle 45. While receptacle 45 is illustrated as being centrally located within case 42, those practiced in the art will readily recognize that dispenser 40 can be configured to house candy pop 30 in any location of receptacle 45 or confectionary compartments 46 by the selective positioning of lids 48. Candy pop 30 includes a support base 34 having a hard candy rod 36 extending downward therefrom and a handle 32 on an opposite end of support base 34 for grasping by a user. Hard candy rod 36 and support base are shaped to closely fit within receptacle 45 for storage and to prevent contamination from dirt and other contaminants when the product is not being consumed by the user.

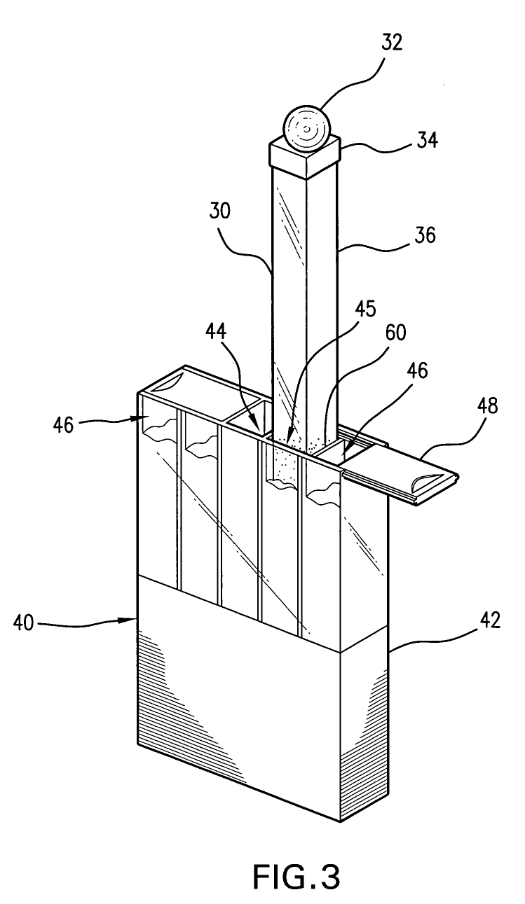

In use, and as shown most clearly in FIG. 3, a user will extract candy pop vertically from receptacle 45 and can then begin to lick or suck on the free end of the hard candy rod extending from support base 34. To enhance the flavor of hard candy rod 36, the user can open one of lids 48 to gain access to one or more confectionary compartments 46. The free end of candy rod 36 can then be inserted into the desired compartment 46 to contact the confectionary powder 60 therein. A quantity of confectionary powder 60 will then adhere to candy rod 36 at which time the user can extract candy rod 36 from compartment 46 and again lick or suck on the free end of candy rod 36 to enjoy the combined flavors of candy rod 36 and confectionary powder 60. Alternatively, the user can also sequentially insert the free end of candy rod 36 in multiple confectionary compartments 46 to adhere more than one flavor of confectionary powders 60, 62 to candy rod 36 prior to consuming. When the user has satiated his or her desire for consumption of the candy, candy pop 30 can then be reinserted into receptacle 45 and lids 48 closed until the user again desires to be treated to candy pop 30 and confectionary powders 60, 62.

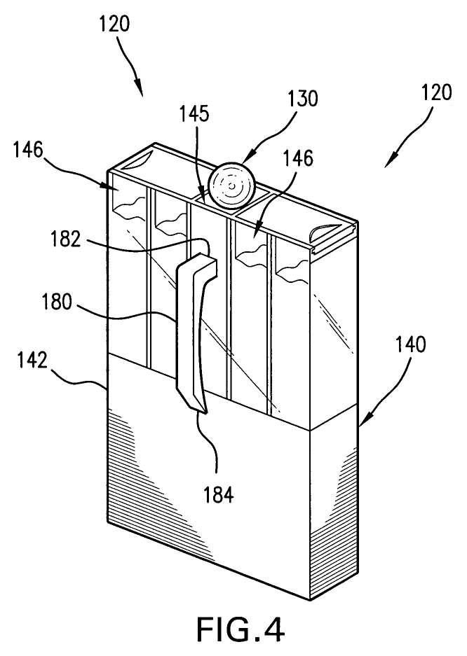

Referring now to FIG. 4, an alternate embodiment candy product 120 is shown which is similar to candy product 20 and comprises a dispenser 140 in which are formed a plurality of confectionary compartments 146 for retaining different flavored confectionary powders and one receptacle 145 in which is retained a candy pop 130. Dispenser 140 includes a case 142 to which is affixed a clip 180. Clip 180 has a top end 182 that is affixed to a side of case 142 and a bottom end 184 that abuts the side of case 142 but is not affixed thereto. Clip 180 has a degree of resiliency such that bottom end can be marginally displaced from case 142 to receive between end 184 and case 142 an item such as a belt or an item of clothing such that candy product 120 can be secured to a users belt or item of clothing to prevent candy product 120 from being inadvertently lost from a clothing pocket in which it is stored or to permit the prominent display of candy product 120 by the user.

In the foregoing description those skilled in the art will readily appreciate that modifications may be made to the invention without departing from the concepts disclosed herein. Such modifications are to be considered as included in the following claims, unless these claims expressly state otherwise.

We/I claim:

1. A candy food product comprising:
a candy pop having a confectionary product formed and supported at a base of a holder; and
a dispenser shaped as a personal electronic device, said container further comprising:
a case divided into a plurality of confectionary compartments for containing a variety of confectionary powders, said confectionary compartments open at a top portion thereof for access to the confectionary powders;
a lid affixed to said case and selectively movable between an open and closed position for permitting access to an interior of said confectionary compartments and for sealing said confectionary compartments to prevent spillage therefrom; and
a receptacle formed in said dispenser proximate to said confectionary compartments and receiving therein said candy pop.

2. The candy food product according to claim 1 wherein said dispenser is covered with an appliqué suggestive of an personal electronic device.

3. The candy food product according to claim 1 wherein said receptacle is centrally positioned in said dispenser.

4. The candy food product according to claim 1 wherein said confectionary compartments contain a plurality of flavored confectionary powders, each said compartment containing a uniquely flavored confectionary powder.
